(19) United States
(12) Patent Application Publication
(10) Pub. No.: US 2020/0231911 A1
(43) Pub. Date: Jul. 23, 2020

(54) ADDITIVE COMPOSITION AND METHOD

(71) Applicant: Dow Global Technologies LLC, Midland, MI (US)

(72) Inventors: Min Zhao, Audubon, PA (US); Liang Chen, Sewickley, PA (US); Xue Chen, Manvel, TX (US)

(21) Appl. No.: 16/632,013

(22) PCT Filed: Jul. 10, 2018
(86) PCT No.: PCT/US2018/041373

§ 371 Date: Jan. 17, 2020

Related U.S. Application Data
(60) Provisional application No. 62/539,170, filed on Jul. 31, 2017.

(51) Int. Cl. C11D 17/00; C11D 3/39; B01J 13/16; C08G 18/32; C08G 18/76

(52) U.S. Cl. CPC C11D 17/0039; C11D 3/3917; C08G 18/7664; C08G 18/3228; B01J 13/16

(57) ABSTRACT

An additive consisting of an active, the active consisting of one or both of tetraacetylethylenediamine or triacetylethylenediamine; and the interfacial polymerization reaction product of a (poly)isocyanate and a polyamine. A method of preparing a water dilution-responsive additive comprising providing an oil phase comprising an active, a solvent, a (poly)isocyanate; providing an aqueous phase comprising water and an emulsifier; mixing the oil phase and the aqueous phase to provide an emulsion; providing a polyamine to the emulsion.

### BACKGROUND

There are many applications where encapsulating an active is desirable. For example, textiles, such as wearable fabrics, are typically washed by contacting the textiles with a detergent formulation that is a combination of detergent components and other optional actives, such as bleaching agents. For ease of use, many detergent formulation users prefer an all-in-one product that incorporates the detergents and optional actives into a single product. Further, many users prefer this product to be a liquid, as compared to a solid or granular product.

One common detergent active is tetraacetylethylenediamine (TAED). TAED functions as a peroxy bleaching activator and a microbial control agent. TAED has been extensively used in solid detergent products. TAED, in liquid detergent formulations which contain in part water, will undergo hydrolysis and lose effectiveness as a detergent active. As the TAED reacts to form N,N′ diacetylethylenediamine (DAED), which is not effective as a detergent active. As such, TAED, when used without modification, is not ideal as an active for an aqueous detergent formulation. Triacetylethylenediamine (TriAED) is another detergent active. An additive containing active that is suitable for use in formulations that contain water is desired.

### SUMMARY OF THE INVENTION

An additive consisting of an active, the active consisting of one or both of tetraacetylethylenediamine or triacetylethylenediamine; and the interfacial polymerization reaction product of a (poly)isocyanate and a polyamine.

A method of preparing a water dilution-responsive additive comprising providing an oil phase comprising an active, a solvent, a (poly)isocyanate; providing an aqueous phase comprising water and an emulsifier; mixing the oil phase and the aqueous phase to provide an emulsion; and providing a polyamine to the emulsion.

### DETAILED DESCRIPTION OF THE INVENTION

The present disclosure describes an improved additive for encapsulating an active. In one aspect, the present disclosure describes an additive emulsion comprising an active, for example, tetraacetylethylenediamine (TAED) or triacetylethylenediamine, and the interfacial polymerization reaction product of a (poly)isocyanate and a polyamine. The improvement of the additive described herein is increased hydrolytic stability for the active which gives enhanced long-term stability in an aqueous formulation. As used herein, “(poly)”isocyanate refers to either or both of a polymeric isocyanate or a monomeric isocyanate.

The (poly)isocyanate is selected from the group consisting of toluene diisocyanate, 4,4′-diphenylmethane diisocyanate, polymethylene polyphenyl isocyanate, isophorone diisocyanate, 1,4-diisocyanatobutane, 1, 4-phenylene diisocyanate, 1,3-phenylene diisocyanate, hexamethylene diisocyanate, 1,3-bis(isocyanatomethyl)benzene, 1,8-diisocyanatooctane, 4-4′-methylenebis(phenyl isocyanate), and 4,4′methylenebis(cyclohexyl isocyanate).

The polyamine is a water-soluble polyamine. The water-soluble polyamine is selected from the group consisting of ethylenediamine, diethylenetriamine, triethylenetretraamine, tetraethylenepentamine, and pentaethylenehexamine.

The (poly)isocyanate and the polyamine are reacted together in an interfacial polymerization reaction. The interfacial polymerization reaction involves a polymerization reaction at the interface between two phases, here an oil phase and an aqueous phase. The oil phase includes the active, the (poly)isocyanate and a solvent. The aqueous phase includes water and an emulsifier. The emulsifier is a nonionic surfactant. The non-ionic surfactant may be a polymeric surfactant of block or random copolymers. Nonionic surfactants include ethoxylated aliphatic or aromatic alcohols, castor-oil based ethoxylates, fatty acid ethoxylates, polyoxyethylene-polyoxypropylene block or random copolymers, sorbitan ester ethoxylates, polyethyleneglycol esters, and polyoxyethylene fatty acid amides. In one instance, the emulsifier is polyvinyl alcohol. Preferred surfactants are Croda's polymeric surfactants and dispersants available under the Atlas and Atlox, tradename. Most preferred is Atlox 4914 a random copolymer of an alkyd-PEG resin. The oil phase and the water phase are mixed to form an emulsion. The polyamine is added to the emulsion, wherein the polyamine and the (poly)isocyanate react via interfacial polymerization.

The solvent is selected from the groups of petroleum fractions or hydrocarbons such as mineral oil, aromatic solvents, xylene, toluene, paraffinic oils, and the like; vegetable oils such as soy bean oil, rape seed oil, olive oil, castor oil, sunflower seed oil, coconut oil, corn oil, cotton seed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, ethylhexyl benzoate, isopropyl benzoate, n-butyl oleate, isopropyl myristate, propylene glycol dioleate, di-octyl succinate, di-butyl adipate, di-octyl phthalate, acetyl tributyl citrate, triethylcitrate, triethyl phosphate, and the like; esters of mono, di and polycarboxylic acids, such as benzylacetate, ethylacetate, and the like; ketones, such as cyclohexanone, acetophenone, 2-heptanone, gamma-butyrolactone, isophorone, amides, such as N-ethyl pyrrolidone, N-octyl pyrrolidone, and the like; alkyldimethylamides, such as dimethylamide of C8 and C10 acids, dimethylacetamide, and the like; alcohols of low water solubility such as benzyl alcohol, cresols, terpineols, tetrahydrofurfurylalcohol, 2-isopropylphenol, cyclohexanol, n-hexanol, and the like. Examples of solvents useful in the present application are Solvesso™ aromatic fluids available from ExxonMobil.

As described herein, the additive encapsulates, or partially encapsulates, the active. As used herein, “encapsulated” refers to the active being bound or retained within the copolymer network. As used herein, the “copolymer network” refers to the product of the interfacial polymerization reaction. The additives described herein are designed to release the active during a triggering event (in the context of the present disclosure, the triggering event might be use in a washing machine). When referring to the active being encapsulated, it refers to the active being retained within the copolymer network prior to the triggering event. The additives prepared according to the methods of the present disclosure have an encapsulating efficiency of 30 to 100 percent. Preferably, the additives prepared according to the methods of the present disclosure have an encapsulating efficiency of 60 to 100 percent. More preferably, the additives prepared according to the methods of the present disclosure have an encapsulating efficiency of 90 to 100 percent. As used herein, “encapsulating efficiency” refers to the percentage of prospective actives that are encapsulated in the copolymer network of the additive.

The additive described herein has a better long-term stability in aqueous systems than actives, such as TAED, alone. For example, when the additive is a detergent additive and is used in a washing machine the active is released from the copolymer, allowing the active to be available in the washing system to perform its detergent-enhancing functionality.

The methods described herein are suitable for preparing other types of additive systems. For example, the methods described herein can include but are not limited to encapsulating fabric softening agents, detergent actives, bleach actives, fertilizers, micronutrients, pesticides (fungicides, bactericides, insecticides, acaricides, nematocides, and the like), biocides, microbial control agents, polymeric lubricants, fire retardants, pigments, dyes, urea inhibitors, food additives, flavorings, pharmaceutical agents, tissues, antioxidants, cosmetic ingredients (fragrances, perfumes and the like), soil amendments (soil repelling agents, soil release agents and the like), catalysts, diagnostic agents and photoprotective agents (UV blockers and the like).

The additives described herein have a dilution-response trigger. Wherein, the active encapsulated within the additive is released by the introduction of excess water. Without being limited by theory, it is expected that the introduction water causes the wall-like structure of the additive to swell, which causes the wall to either burst or form channels through which the active can be release from the additive.

### EXAMPLES

### Materials and Encapsulated Examples

Solvesso™ 200 fluid, commercially available from Exxon Mobil, is characterized as a complex mixture of aromatic hydrocarbons obtained from distillation of aromatic streams derived from crude oil.
Atlox™ 4914, commercially available from Croda, is a nonionic polymeric surfactant with a low HLB value of 6.
PAPI 27, commercially available from the Dow Chemical Company, is a polymethylene polyphenylisocyanate that contains MDI. It has an average molecular weight of 340 and an isocyanate equivalent weight of 134.0, and NCO content by weight of 31.4%.
Polyvinyl alcohol: Celvol 203 from Kuraray.
TAED: commercially available from Sigma-Aldrich
Ethylenediamine is obtained from The Dow Chemical Company.

Experimental Procedure

Encapsulation by Interfacial Polymerization

Following the formulation in Table 1, the targeted surfactant Atlox 4914 and 10% TAED powder were added to the solvent Solvesso 200. The mixture was mixed vigorously via a vortex mixer to form a suspension of TAED. Polyisocyanate (PAPI 27) was then added and well mixed. The above mixture was used as the oil phase. The aqueous phase was prepared by adding polyvinyl alcohol to water to make a 4.5% solution.

The aqueous phase was poured to the top of oil phase and the mixture was emulsified via a Silverson L5 high shear mixer to generate emulsion.

Ethylenediamine in a water solution (30%) was then added and the mixture was allowed to stir at ambient temperature for at least 30 min.

TABLE 1
Formulation 1

| Component | Wt (g) | Wt % |
|---|---|---|
| Solvesso 200 | 12.62 | 35.7% |
| PAPI 27 | 0.73 | 2.1% |
| TAED | 1.50 | 4.2% |
| Atlox 4914 | 0.15 | 0.4% |
| EDA | 0.10 | 0.3% |
| Celvol 205 | 0.90 | 2.5% |
| Water | 19.33 | 54.7% |
| Total | 35.33 | 100.0% |

Microscopy Evaluation

For the release mechanism of the active, the encapsulated material was placed in water. While using a Zeiss Axio Imager microscope it was observed that on dilution with water, the polyurea shell began to expand resulting in the outer shell breaking and releasing the oil phase containing the active (TAED).

HPLC Method Evaluation

1 droplet (ca. 0.1 g) of the example formulation was added to 10 g H₂O solvent and mixed for 1 minute and analyzed using HPLC. This analysis is labeled as test 1. To investigate the dilution trigger, for comparison, 1 droplet (ca. 0.1 g) of the example formulation was added to 10 g of H₂O with mixing for 20 min, and analyzed using HPLC. This analysis is labeled as test 2. The concentration of TAED and DAED of the prepared samples were measured using Agilent 1100 High-Performance Liquid Chromatography (HPLC) with quaternary pump and diode array detector. The HPLC method conditions are summarized in the table below.

TABLE 2
HPLC Testing Conditions

| System | Agilent 1100 with quaternary pump and diode array detector | | |
|---|---|---|---|
| Column | Eclipse XDB-C18: 4.6 mm × 50 mm × 5 μm | | |
| Column | 40° C. | | |
| Temperature | | | |
| Injection Volume | 1 μL sample | | |
| Flow Rate | 1 mL/min | | |
| Mobile Phases | A = 18.2 MΩ-cm water, B = acetonitrile | | |
| | Time | Composition | |
| Gradient | (min) | % A | % B |
| | 0.0 | 65 | 35 |
| | 3.5 | 0 | 100 |
| | 5.5 | 0 | 100 |

| | |
|---|---|
| Equilibration Time | 2.5 min |
| Total Run Time | ~10 |
| Detection | UV (DAD) @ 216 nm, BW 4 nm, 1 cm cell (TAED) |
| | UV (DAD) @ 205 nm, BW 4 nm, 1 cm cell (DAED) |

The results are shown in Table 3. Based on Test 1 which does not involve the water dilution process, the DAED concentration is 0%, indicating good encapsulation, while for Test 2 involves mixing the encapsulated material in water for 20 minutes, the DAED concentration is 0.0244%. The DAED is formed as a result of the hydroloysis of TAED released from the encapsulated material. The HPLC analysis of these materials is consistent with the shell breaking phenomena detected by microscopy.

TABLE 3
HPLC results of Formulation 1 before and after dilution

| | DAED | TAED |
|---|---|---|
| sample ID | concentration % | concentration % |
| Test 1 | 0 | 0.663 |
| Test 2 | 0.0244 | 0.715 |

1. An additive consisting of:
an active, the active consisting of one or both of tetraacetylethylenediamine or triacetylethylenediamine; and
the interfacial polymerization reaction product of a (poly)isocyanate and a polyamine.

2. The additive of claim 1, wherein the (poly)isocyanate is selected from the group consisting of toluene diisocyanate, 4,4′-diphenylmethane diisocyanate, polymethylene polyphenyl isocyanate, isophorone diisocyanate, 1,4-diisocyanatobutane, 1, 4-phenylene diisocyanate, 1,3-phenylene diisocyanate, hexamethylene diisocyanate, 1,3-bis(isocyanatomethyl)benzene, 1,8-diisocyanatooctane, 4-4′-methylenebis(phenyl isocyanate), and 4,4′methylenebis(cyclohexyl isocyanate).

3. The additive of claim 1, wherein the polyamine is a water-soluble polyamine.

4. The additive of claim 3, wherein the water-soluble polyamine is selected from the group consisting of ethylenediamine, diethylenetriamine, triethylenetretraamine, tetraethylenepentamine, and pentaethylenehexamine.

5. The additive of claim 1, wherein the encapsulating efficiency of the active in the additive is from 60 to 100 percent.

6. A method of preparing a water dilution-responsive additive comprising:
providing an oil phase comprising an active, a solvent, a (poly)isocyanate;
providing an aqueous phase comprising water and an emulsifier;
mixing the oil phase and the aqueous phase to provide an emulsion; and
providing a polyamine to the emulsion.

7. The method of claim 6, wherein the polyisocyanate is selected from the group consisting of toluene diisocyanate, 4,4′-diphenylmethane diisocyanate, polymethylene polyphenyl isocyanate, isophorone diisocyanate, 1,4-diisocyanatobutane, 1, 4-phenylene diisocyanate, 1,3-phenylene diisocyanate, hexamethylene diisocyanate, 1,3-bis(isocyanatomethyl)benzene, 1,8-diisocyanatooctane, 4-4′-methylenebis(phenyl isocyanate), and 4,4′methylenebis(cyclohexyl isocyanate).

8. The method of claim 6, wherein the polyamine is selected from the group consisting of ethylenediamine, diethylenetriamine, triethylenetretraamine, tetraethylenepentamine, and pentaethylenehexamine.

9. The method of claim 6, wherein the solvent has a water solubility of 10 grams per 100 milliliters or less.

10. The method of claim 6, wherein the solvent is selected from the groups of petroleum fractions or hydrocarbons such as mineral oil, aromatic solvents, xylene, toluene, paraffinic oils, and the like; vegetable oils such as soy bean oil, rape seed oil, olive oil, castor oil, sunflower seed oil, coconut oil, corn oil, cotton seed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, ethylhexyl benzoate, isopropyl benzoate, n-butyl oleate, isopropyl myristate, propylene glycol dioleate, di-octyl succinate, di-butyl adipate, di-octyl phthalate, acetyl tributyl citrate, triethylcitrate, triethyl phosphate, and the like; esters of mono, di and polycarboxylic acids, such as benzylacetate, ethylacetate, and the like; ketones, such as cyclohexanone, acetophenone, 2-heptanone, gamma-butyrolactone, isophorone, N-ethyl pyrrolidone, N-octyl pyrrolidone, and the like; alkyldimethylamides, such as dimethylamide of C8 and C10, dimethylacetamide, and the like; alcohols of low water solubility such as benzyl alcohol, cresols, terpineols, tetrahydrofurfurylalcohol, 2-isopropylphenol, cyclohexanol, n-hexanol, and the like.

11. The method of claim 6, wherein the active consists of one or both of tetraacetylethylenediamine or triacetylethylenediamine.
